(19) United States
(12) Patent Application Publication
(10) Pub. No.: US 2007/0183488 A1
(43) Pub. Date: Aug. 9, 2007

(54) TTR offset control apparatus and method in asymmetric digital subscriber line

(76) Inventor: Hye-Won Kang, Suwon-si (KR)

Correspondence Address: Robert E. Bushnell, Suite 300, 1522 K Street, N.W., Washington, DC, 20005, US

(21) Appl. No.: 11/641,891

(22) Filed: Dec. 20, 2006

(30) Foreign Application Priority Data
Feb. 3, 2006 (KR) 10-2006-0010879

(51) Int. Cl. H04B 1/38; H04L 7/00

(52) U.S. Cl. 375/222; 375/354

(57) ABSTRACT

The present invention relates to an apparatus and method for TCM Timing Reference (TTR) offset control in an Asymmetric Digital Subscriber Line (ADSL), the apparatus and method controlling TTR offset in order to remove Near End Crosstalk (NEXT) or Far End Crosstalk (FEXT) noise which would otherwise take place in services due to matching between an Asymmetric Digital Subscriber Line (ADSL) and a Time-Compression Multiplexing Integrated Service Digital Network (TCM-ISDN). The offset control method includes the steps of: synchronizing first and second clocks with each other, the first and second clocks being synchronized with a TTRc clock which is a reference clock for entering the ADSL equipment; dividing the synchronized second clock into a predetermined magnitude of a third clock; classifying the TTRc clock into high and low clocks by using the divided third clock and counting the high and low clocks, respectively; and compensating the counted high and low clocks according to a preset offset adjustment value so as to produce a compensated fourth clock, and providing the fourth clock, together with the first and second clocks, to the ADSL equipment.

### CLAIM OF PRIORITY

This application makes reference to, incorporates the same herein, and claims all benefits accruing under 35 U.S.C.§ 119 from an application for APPARATUS AND METHOD FOR CONTROLLING OFFSET OF TTR CLOCK IN ADSL earlier filed in the Korean Intellectual Property Office on the 3^{rd} of February 2006 and there duly assigned Serial No. 10-2006-0010879.

### BACKGROUND OF THE INVENTION

1. Technical Field

The present invention relates to an apparatus and method for Time-Compression Multiplexing Timing Reference (TTR) offset control in an Asymmetric Digital Subscriber Line (ADSL) and, more particularly, an apparatus and method which can control TTR offset in order to remove Near End Crosstalk (NEXT) or Far End Crosstalk (FEXT) noise that would otherwise take place in services due to matching between an ADSL and a Time-Compression Multiplexing Integrated Services Digital Network (TCM-ISDN).

2. Related Art

Voice over Internet Protocol (VoIP) is an Internet telecommunication technology used for devices that transfer voice information via Internet Protocol (IP). Unlike other protocols using lines, such as the Public Switched Telephone Network (PSTN), VoIP is used to transfer digitized voice information in discontinuous packets.

In general, the Asymmetric Digital Subscriber Line (ADSL) technology advantageously has enabled users to enjoy a high-speed data communication service while using a Plain Old Telephone Service (POTS) based on a telephone line. The ADSL technology provides high data transmission speed up to 8 Mbps in downloading and up to 640 Kbps in uploading.

However, when electric energy is transmitted through copper wires in a telephone network, modulated signals dissipate energy to an adjacent copper wire of the same cable. Such electromagnetic energy and cross coupling are called crosstalk.

In a typical telephone network, a pair of insulated copper wires are bound with a cable called cable binder. In such a cable binder transferring information in the same frequency bandwidth, adjacent systems have crosstalk interference that cannot be neglected. Then, signals transmitted through copper wires have a waveform which is slightly different from what it is supposed to be.

Such crosstalk can be classified into two types. One type is called Near End Crosstalk (NEXT), which is very important since a high-energy signal from an adjacent system may induce very large crosstalk in a native signal. That is, NEXT is an important barometer of any crosstalk noise between two units at the same end used in communication.

The other crosstalk type is called Far End Crosstalk (FEXT), which is measured from disturbance at a far end of a pair of copper wires when a test signal is sent at one end of a channel to the copper wires. Therefore, FEXT refers to crosstalk noise in data communication with a communication unit at the opposite or far end of the copper wires. FEXT is smaller than NEXT since far end interference signals are attenuated while being transmitted through copper wires.

In an environment where a Time-Compression Multiplexing Integrated Services Digital Network (TCM-ISDN) is installed, NEXT and FEXT noise sources are called TCM-ISDN interference. A TCM-ISDN system alternately performs upstream and downstream transmissions of data in a period called TCM Timing Reference (TTR). An ISDN central station transmits data to an ISDN remote station in the first half period of TTR, and the ISDN remote station transmits data to the ISDN central station in the second half period of TCM Timing Reference (TTR).

In order to efficiently perform ADSL data communication in such a TCM-ISDN environment, an ADSL transceiver transmits a large quantity of data in FEXT sections but rarely transmits data in NEXT sections.

Approaches to minimizing FEXT interference include several techniques such as dual bit map, single bit map and SNR. The dual bit map technique uses different bit maps according to FEXT/NEXT sections, but the single bit map technique transmits data only in FEXT sections where crosstalk interference is small. SNR is a combination of these two bit map techniques. When an ADSL service is provided in a TCM-ISDN environment, NEXT interference is larger than FEXT interference across all sections. The transmission rate of data can be maximized when correct network time synchronization is performed between ADSL and TCM-ISDN services and data is transmitted by means of the dual bit map technique.

In general, in a service where ADSL is matched with TCM-ISDN, ADSL equipment suffers from FEXT and NEXT crosstalk noises originating from TCM_ISDN equipment. As a measure to avoid such crosstalk noise, TTRc (reference clock to enter the ADSL equipment) is fed to the ADSL equipment so as to transmit data in a small quantity at NEXT, which has relatively large noise, but to transmit data in a large quantity at FEXT (see ITU-T G.992.1 ANNEX C Specification). This, however, creates TTR and TTRc offset due to propagation delay according to the distance between TTR and NTR sources and the ADSL equipment, and due to system delay. TTR and TTRc offset are defined by Max 49.819 μs according to the ITU-T 992.1 Specification.

Unless such offset is not compensated, FEXT noise sections, where a large quantity of data is transmitted, will overlap NEXT noise sections. As a result, this may damage data while being transmitted by the ADSL equipment or create a large quantity of CRC, thereby causing various problems such as ADSL link down or SNR margin down.

### SUMMARY OF THE INVENTION

The present invention has been developed to solve the foregoing problems, and therefore an object of certain embodiments of the present invention is to provide a TCM Timing Reference (TTR) offset control apparatus and method for use in an Asymmetric Digital Subscriber Line (ADSL) which can programmably compensate TTR and TTRc offset by using ADSL chip clock, PLL and PLD so as to prevent overlapping of Far End Crosstalk (FEXT) noise sections where data is transmitted in a large quantity with Near End Crosstalk (NEXT) noise sections. In accordance with the invention, offset control can be performed programmably by operator manipulation to prevent crosstalk noise and ensure stable data service.

Another object of certain embodiments of the present invention is to provide a TTR offset control apparatus and method for use in an ADSL which can acquire a propagation delay value between a TTR clock source and a present system by using a Time Domain Reflectometry (TDR) function of ADSL SELT (ITU-T G.922. 1 Specification), and which can compensate the offset of acquired propagation delay value as much as delay by using a program of a PLD chip in order to prevent overlapping of FEXT noise sections where data is transmitted in a large quantity with NEXT noise sections, thus enabling stable data service.

According to an aspect of the invention for realizing the above objects, the invention provides an offset control method for ADSL equipment in matching the ADSL equipment with Time-Compression Multiplexing Integrated Services Digital Network (TCM-ISDN) equipment, the method comprising the steps of: synchronizing first and second clocks with each other, the first and second clocks being synchronized with TTRc which is a reference clock to enter the ADSL equipment; dividing the synchronized second clock into a predetermined magnitude of a third clock; classifying the TTRc clock into high and low clocks by using the divided third clock, and counting the high and low clocks, respectively; and compensating the counted high and low clocks according to a preset offset adjustment value so as to produce a compensated fourth clock, and providing the fourth clock, together with the first and second clocks, to the ADSL equipment.

The first clock is preferably an NTR clock, the second clock is preferably an ADSL DSP clock, and the fourth clock is preferably a TTRp clock to enter the ADSL equipment.

The preset offset adjustment value is preferably a bit value set by a user with a switch or a propagation delay value obtained by the ADSL equipment using TDR of an SELT function.

According to another aspect of the invention for realizing the above objects, the invention provides an offset control method for ADSL equipment in matching of the ADSL equipment with TCM-ISDN equipment, the method comprising the steps of: synchronizing NTR and ADSL DSP clocks with each other, the NTR and ADSL DSP clocks being synchronized with TTRc which is a reference clock to enter the ADSL equipment; dividing the synchronized ADSL DSP clock into a predetermined magnitude; classifying the TTRc clock into high and low clocks by using the divided clock, and counting the high and low clocks, respectively; and compensating the counted high and low clocks in high and low periods, respectively, according to an offset adjustment value set by user selection so as to produce a compensated TTRp clock, and providing the TTRp clock, together with the NTR and ADSL DSP clocks, to the ADSL equipment.

The offset adjustment value is preferably set by a user with a dip switch having a predetermined bit set according to an adjustment range.

The NTR clock is preferably 8 KHz, the ADSL DSP clock is preferably 32.328 MHZ, the TTRc clock is preferably 400 Hz, and the divided clock is preferably 276 KHz.

In counting the high and low clocks, each of the high and low clocks is preferably counted with a 9-bit counter according to the divided clock.

According to a further aspect of the invention for realizing the above objects, the invention provides an offset control method for ADSL equipment in matching of the ADSL equipment with TCM-ISDN equipment, the method comprising the steps of: synchronizing NTR and ADSL DSP clocks with each other, the NTR and ADSL DSP clocks being synchronized with TTRc which is a reference clock to enter the ADSL equipment; dividing the synchronized ADSL DSP clock into a predetermined magnitude; classifying the TTRc clock into high and low clocks by using the divided clock, and counting the high and low clocks, respectively; and offset-compensating the counted high and low clocks in high and low periods, respectively, according to a propagation delay value provided by the ADSL equipment so as to produce a compensated TTRp clock, and providing the TTRp clock, together with the NTR and ADSL DSP clocks, to the ADSL equipment.

The propagation delay value is preferably acquired by the ADSL equipment using TDR of an SELT function.

The NTR clock is preferably 8 KHz, the ADSL DSP clock is preferably 32.328 MHZ, the TTRc clock is preferably 400 Hz, and the divided clock is preferably 1.1 MHZ.

In the counting of the high and low clocks, each of the high and low clocks is preferably counted with an 11-bit counter according to the divided clock.

According to another aspect of the invention for realizing the above objects, the invention provides an offset control apparatus for ADSL equipment in matching of the ADSL equipment with TCM-ISDN equipment, the apparatus comprising: a synchronizer for synchronizing first and second clocks with each other, the first and second clocks being synchronized with TTRc which is a reference clock to enter the ADSL equipment; and an offset compensator for dividing the synchronized second clock outputted from the synchronizer into a predetermined magnitude of a third clock, for classifying the TTRc clock into high and low clocks by using the divided third clock, for counting the high and low clocks, respectively, for compensating the counted high and low clocks according to a preset offset adjustment value so as to produce a compensated fourth clock, and for providing the fourth clock, together with the first and second clocks, to the ADSL equipment.

The offset control apparatus preferably further comprises an offset adjustment value selector for providing the offset adjustment value to the offset compensator according to user selection.

The offset adjustment value selector preferably comprises a dip switch having a predetermined bit, or the preset offset adjustment value may be a propagation delay value obtained by the ADSL equipment using TDR of an SELT function.

According to another aspect of the invention for realizing the above objects, the invention provides an offset control apparatus for ADSL equipment in matching of the ADSL equipment with TCM-ISDN equipment, the apparatus comprising: a synchronizer for synchronizing NTR and ADSL DSP clocks with each other, the NTR and ADSL DSP clocks being synchronized with a TTRc clock; an offset compensator for dividing the synchronized ADSL DSP clock provided by the synchronizer into a predetermined magnitude, for classifying the TTRc clock into high and low clocks by using the divided clock, for counting the high and low clocks, respectively, for compensating the counted high and low clocks in high and low periods, respectively, according to a provided offset adjustment value so as to produce a compensated TTRp clock, and for providing the TTRp clock, together with the NTR and ADSL DSP clocks, to the ADSL equipment; and an offset adjustment value selector for providing the offset adjustment value to the offset compensator according to user selection.

The offset adjustment value selector preferably comprises a dip switch having a predetermined bit set according to an adjustment range.

The NTR clock is preferably 8 KHz, the ADSL DSP clock is preferably 32.328 MHZ, the TTRc clock is preferably 400 Hz, and the divided clock is preferably 276 KHz.

The offset compensator preferably comprises counters, each counting each of the high and low clocks according to the divided clock.

According to yet another aspect of the invention for realizing the above objects, the invention provides an offset control apparatus for ADSL equipment in matching of the ADSL equipment with TCM-ISDN equipment, the apparatus comprising: a synchronizer for synchronizing NTR and ADSL DSP clocks with each other, the NTR and ADSL DSP clocks being synchronized with a TTRc clock; and an offset compensator for dividing the synchronized ADSL DSP clock into a predetermined magnitude, for classifying the TTRc clock into high and low clocks by using the divided clock, for counting the high and low clocks respectively, for offset-compensating the counted high and low clocks in high and low periods, respectively, according to a propagation delay value provided by the ADSL equipment so as to produce a compensated TTRp clock, and for providing the TTRp clock, together with the NTR and ADSL DSP clocks, to the ADSL equipment.

The propagation delay value is preferably acquired by the ADSL equipment using TDR of an SELT function.

The NTR clock is preferably 8 KHz, the ADSL DSP clock is preferably 32.328 MHZ, the TTRc clock is preferably 400 Hz, and the divided clock is preferably 1.1 MHZ.

The offset compensator preferably comprises counters, each counting each of the high and low clocks according to the divided clock.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of a TCM Timing Reference (TTR) offset control apparatus in an Asymmetric Digital Subscriber Line (ADSL) according to a first embodiment of the invention;

FIG. 2 is an internal process flowchart of a Programmable Logic Device (PLD) shown in FIG. 1;

FIG. 3 is a timing diagram of a TTRp clock outputted with its offset compensated with respect to TTRc by a dip switch according to the first embodiment of the invention;

FIG. 4 is a block diagram illustrating a TTR offset control apparatus in an ADSL using propagation delay values provided by ADSL equipment according to a second embodiment of the invention;

FIG. 5 is an internal process flowchart of a PLD shown in FIG. 4; and

FIG. 6 is a timing diagram of a TTRp clock outputted with its offset compensated 1s according to propagation delay values provided by ADSL equipment with respect to a TTRc clock according to the second embodiment of the invention.

### DETAILED DESCRIPTION OF THE INVENTION

The present invention will now be described more fully hereinafter with reference to the accompanying drawings, in which preferred embodiments of an apparatus and method for controlling TCM Timing Reference (TTR) offset in an Asymmetric Digital Subscriber Line (ADSL) of the invention are shown.

### First Embodiment

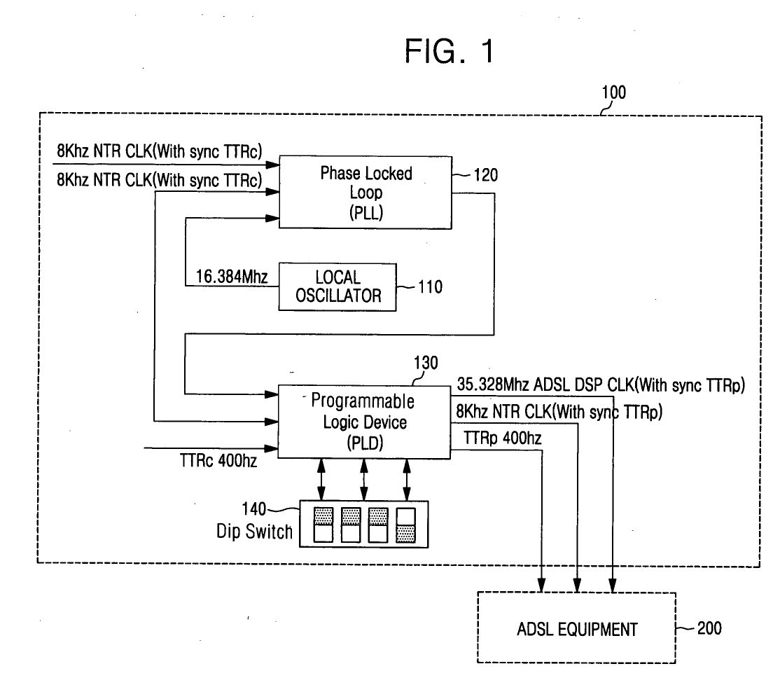

FIG. 1 is a block diagram of an apparatus for controlling TTR offset in an Asymmetric Digital Subscriber Line (ADSL) according to a first embodiment of the invention.

As shown in FIG. 1, an offset control apparatus 100 of the invention is connected to ADSL equipment 200. The offset control apparatus 100 includes a local oscillator 110, a Phase Locked Loop (PLL) 120, a Programmable Logic Device (PLD) 130, and a dip switch 140.

The PLL 120 compensates the phase of an 8 KHz input NTR clock synchronized with a TTRc clock, by using an oscillation frequency of 16.384 MHZ provided by the local oscillator 110, so as to synchronize with a 32.328 MHZ ADSL DSP clock, and then provides it to the PLD 130. The PLL 120 also provides an 8 KHz input NTR clock, synchronized with the TTRc clock, to the PLD 130.

By using programmable logic according to adjustment values of the dip switch 140, the PLL 130 converts the 400 Hz TTRc clock and TTRc-synchronized 35.328 MHZ and 8 KHz clocks provided by the PLL 120 into a TTRp clock and TTRp-synchronized 35.328 MHZ and 8 KHz clocks, and provides them to a DSP (not shown) of the ADSL equipment 200.

The dip switch 140 is a 4-bit dip switch capable of expressing 0 to 15, in which a bit number can be increased and adjusted if precise adjustment is desired. Offset is compensated by about 3.6 us whenever the dip switch 140 increases by 1. Since the standard defines max offset by about 50 μs (ITU-T 992.1 Specification defines TTR and TTRc offset by Max 49.819 μs), the 4-bit dip switch has enough offset 3.6×15=54. The dip switch 140 can be adjusted programmably from outside.

The operation of the ADSL TTR offset control apparatus configured as above according to the first embodiment of the invention is described as follows.

First, as shown in FIG. 1, the PLL 120 compensates the phase of an 8 KHz input NTR clock synchronized with TTRc by using an oscillation frequency of 16.384 MHZ provided by the local oscillator 110 so as to synchronize with a 32.328 MHZ ADSL DSP clock which will enter the ADSL DSP, and then provides it to the PLD 130. The PLL 120 also provides an 8 KHz input NTR clock synchronized with TTRc to the PLD 130.

By using programmable logic according to adjustment values of the dip switch 140, the PLL 130 converts a 400 Hz TTRc clock and TTRc-synchronized 35.328 MHZ and 8 KHz clocks provided by the PLL 120 into a TTRp clock and TTRp-synchronized 35.328 MHZ and 8 KHz clocks, and provides them to the DSP (not shown) of the ADSL equipment 200.

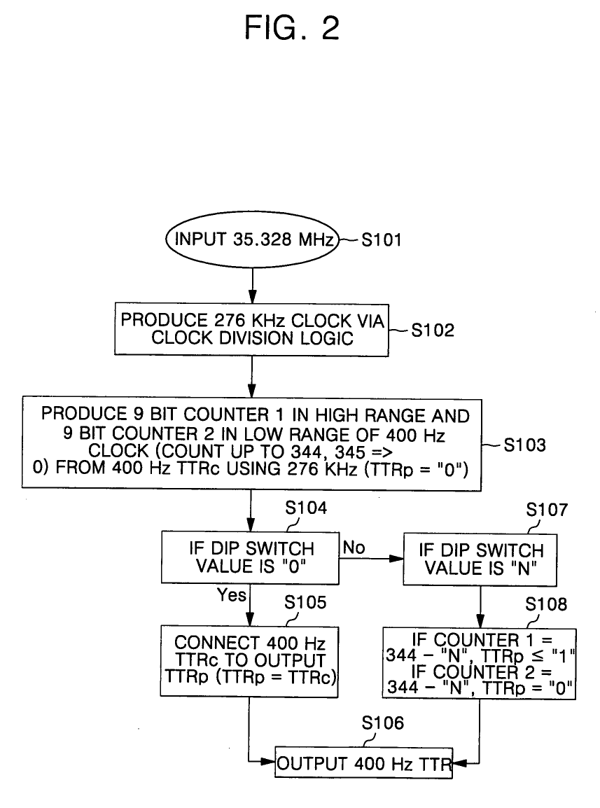

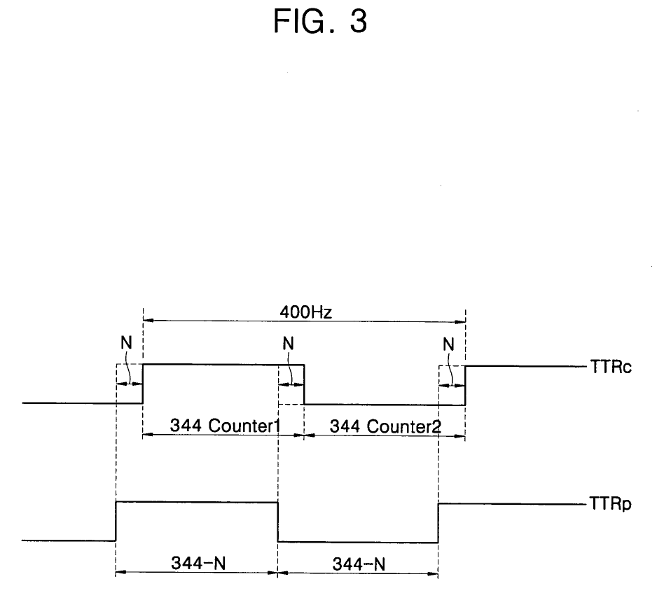

The programmable logic which the PLD 130 uses to adjust offset according to the switching adjustment values of the dip switch 140 will now be described in detail with reference to FIGS. 2 and 3.

FIG. 2 is an internal process flowchart of the PLD shown in FIG. 1, and FIG. 3 is a Is timing diagram of a TTRp clock outputted with its offset compensated with respect to TTRc by a dip switch according to the first embodiment of the invention.

As shown in FIG. 2, when a TTRc-synchronized 35.328 MHZ ADSL DSP clock is inputted from the PLL 120 in S101, the PLD 130 converts the 35.328 MHZ ADSL DSP clock into a 276 KHz clock through division logic in S102. That is, the 35.328 MHZ ADSL DSP clock is divided into a 276 KHz clock having about 3.623 μs per cycle.

In S103, the PLD 130 converts a 400 Hz TTRc clock into a 9-bit counter 1 in a high range of the 400 Hz clock and 9-bit counter 2 in a low range of the same clock by using a 276 KHz clock generated through the division logic. That is, 400 Hz TTRc is divided into high and low ranges to operate a counter at 276 KHz. In this case, counting up to 344 with two 9-bit counters can be accomplished, and 345 becomes “0.”

Accordingly, TTRp which will be adjusted in offset is outputted by using such counters. If the dip switch 140 has an adjustment value of “0” (that is, the dip switch 140 is not adjusted) in S104, a 400 Hz input TTRc is connected to a TTRp output port in S105, and is outputted as a TTRp value to the DSP of the ADSL equipment 200 in S 106. That is, since the dip switch 140 is not adjusted, TTRc and TTRp are commonly outputted to the DSP of the ADSL equipment 200 without offset adjustment.

However, if the dip switch 140 does not have an adjustment value of “0” in S104 but has an adjustment value of “N” in S107, compensation is made by 3.623×N μs in S108 and is outputted as a TTRp value in S106. That is, counter 2 compensates up to 344−N of TTRp as high (1) and up to 3440−N of TTRp as low (0), as shown in S108 of FIG. 2, so as to output a 400 Hz TTRp clock to the DSP of the ADSL equipment 200 in S106 of FIG. 2.

Summarizing the first embodiment of the invention as set forth above, clocks synchronized with TTRc by the PLL 120 are adjusted in offset according to the settings of the dip switch 140 so as to be converted into TTRp clocks, which are in turn provided to the ADLS equipment 200.

Referring to the internal logic of the PLD 130, a synchronized 35.328 MHZ ADSL DSP clock inputted by the PLL 120 is converted into a 276 KHz clock by division logic, and the counters are operated using the 276 KHz clock in high and low ranges of a 400 Hz input clock. In this case, the counters are two 9-bit counters which count up to 344 with count 345 being “0.”

By using the two counters, a TTRp clock, with the offset between TTR and TTRc compensated according to the settings of the dip switch 140, is outputted to the DSP of the ADSL equipment 200. That is, a change in the setting of the dip switch 140 allows offset compensation as desired by the user.

As a result, according to the first embodiment of the invention, with the offset of a TTRp clock between TTR and TTRc being compensated using the high and low counters according to the settings of the dip switch 140, the TTRp clock is outputted to the DSP of the ADSL equipment 200, in which change in the settings of the dip switch 140 allows offset compensation according to the demands of the user.

### Second Embodiment

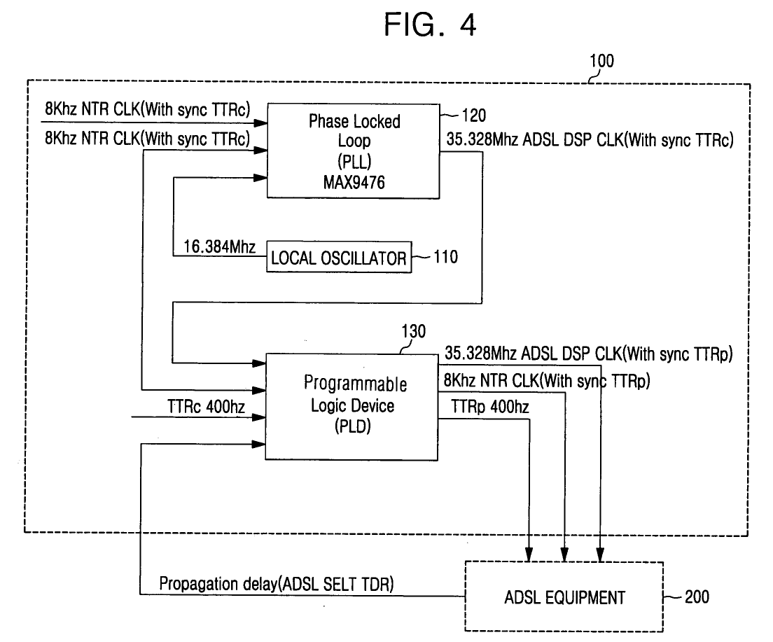

FIG. 4 is a block diagram illustrating a TTR offset control apparatus in an ADSL using propagation delay values provided by ADSL equipment according to a second embodiment of the invention.

As shown in FIG. 4, an offset control apparatus 100 of the invention is connected to ADSL equipment 200, and includes a local oscillator 110, a PLL 120, a PLD 120, and a dip switch 130.

The PLL 120 compensates the phase of an 8 KHz input NTR clock synchronized with a TTRc clock, by using an oscillation frequency of 16.384 MHZ provided by the local oscillator 110, so as to synchronize with a 32.328 MHZ ADSL DSP clock, and then provides it to the PLD 130. The PLL 120 also provides an 8 KHz input NTR clock, synchronized with the TTRc clock, to the PLD 130.

By using propagation delay values obtained through SELT TDR of the ADSL 200, the PLL 130 converts a 400 Hz TTRc clock and TTRc-synchronized 8 KHz and 35.328 MHZ clocks provided by the PLL 120 into a TTRp clock and TTRp-synchronized 35.328 MHZ and 8 KHZ clocks, and provides them to a DSP (not shown) of the ADSL equipment 200.

The operation of the ADSL TTR offset control apparatus configured as above according to the second embodiment of the invention is disclosed as follows.

First, as shown in FIG. 3, the local oscillator 110 generates an oscillation frequency of 16.384 MHZ which is provided to the PLL 120. The PLL 120 compensates the phase of an 8 KHz input NTR clock synchronized with the TTRc clock by using an oscillation frequency of 16.384 MHZ provided by the local oscillator 110 so as to synchronize with a 32.328 MHZ ADSL DSP clock which will enter the ADSL DSP, and then provides it to the PLD 130. The PLL 120 also provides an 8 KHz input NTR clock synchronized with TTRc to the PLD 130.

By using propagation delay values obtained through SELT TDR of the ADSL equipment 200, the PLL 130 converts a 400 Hz TTRc clock and TTRc-synchronized 35.328 MHZ and 8 KHz clocks provided by the PLL 120 into a TTRp clock and TTRp-synchronized 35.328 MHZ and 8 KHz clocks, and provides them to the DSP (not shown) of the ADSL equipment 200.

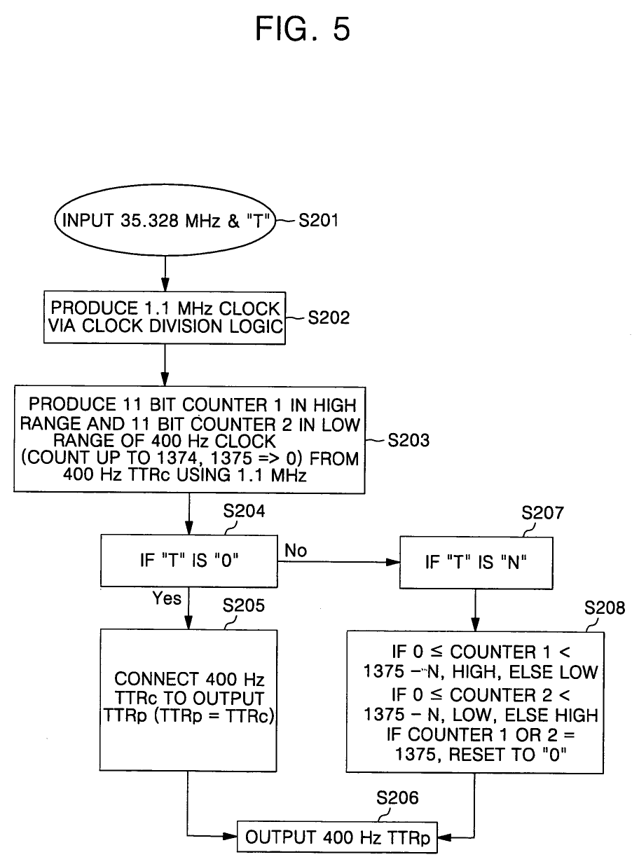

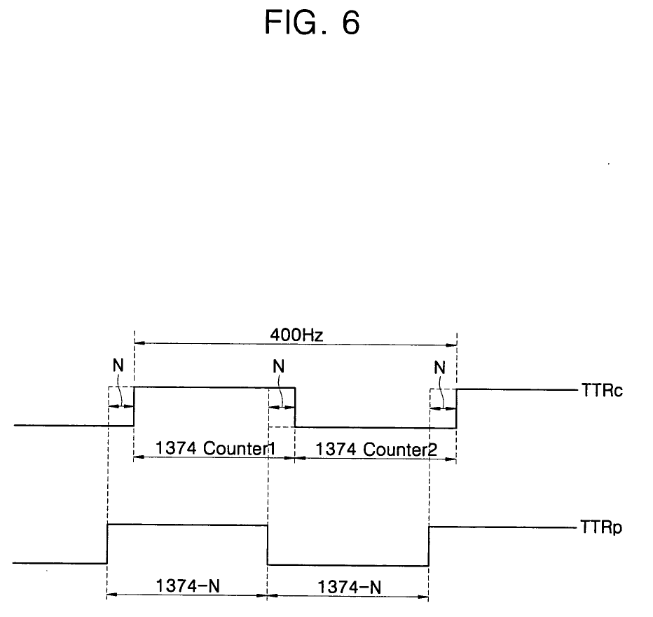

The programmable logic which the PLD 130 uses to adjust offset according to the propagation delay values provided from the ADSL 200 will now be described in detail with reference to FIGS. 5 and 6.

FIG. 5 is an internal process flowchart of a PLD shown in FIG. 4, and FIG. 6 is a timing diagram of a TTRp clock outputted with its offset compensated according to propagation delay values provided by ADSL equipment with respect to a TTRc clock according to the second embodiment of the invention.

First, the ADSL equipment 200 obtains a propagation delay value according to a cable connected to a subscriber terminal by using an SELT TDR function, and provides the propagation delay value to the PLD 130 of the offset control apparatus 100.

When a TTRc-synchronized 35.328 MHZ ADSL DSP clock is inputted from the PLL 120 and a propagation delay value T is inputted from the ADSL equipment 200 in S201, the 11 PLD 130 divides the 35.328 MHZ ADSL DSP clock into a 276 KHz clock by a division logic so as to generate a 1.1 MHZ clock of about 0.91 s per cycle in S202.

In S203, the PLD 130 converts a 400 Hz TTRc clock into an 11-bit counter 1 in a high range and an 11-bit counter 2 in a low range by using a 1.1 MHZ clock generated by the division logic. That is, 400 Hz TTRc is divided into high and low ranges to operate a counter at 1.1. MHZ. In this case, counting up to 1394 with two 11-bit counters can be accomplished, and 1395 becomes “0.”

Accordingly, TTRp which will be adjusted in offset is outputted by using such counters. If a propagation delay value T provided by the ADSL equipment 200 is “0” in S204, a 400 Hz input TTRc is connected to a TTRp output port in S205, and is outputted as a TTRp value to the DSP of the ADSL equipment 200 in S206. That is, since there is no propagation delay in the ADSL equipment 200, TTRc and TTRp values are commonly outputted to the DSP of the ADSL equipment 200 without offset adjustment.

However, if the propagation delay value provided from the ADSL equipment 200 is not “0” in S204 but is “N” in S207, compensation is made by 0.91×N μs in S208 and is outputted as a 400 Hz TTRp in S206. That is, counter 1 compensates up to 1395−N of TTRp as high and up to 1395−N of TTRp as low as shown in S208 of FIG. 6 so as to output a 400 Hz TTRp clock to the DSP of the ADSL equipment 200 in S206.

Summarizing the second embodiment of the invention as set forth above, clocks 8 synchronized with a TTRc clock by the PLL 120 are compensated so as to convert into TTRp clocks according to the propagation delay value provided by the ADSL 200 via the PLD 130, and are then provided to the ADLS equipment 200.

Referring to the internal logic of the PLD 130, a synchronized 35.328 MHZ ADSL DSP clock inputted by the PLL 120 is converted into a 1.1 MHZ clock by the division logic, and the counters are operated using the 1.1 MHZ clock in high and low ranges of the 400 Hz input clock. In this case, the counters are two 9-bit counters which count from 1 to 1374 with count 1375 being “0.”

By using the two counters, a TTRp clock is outputted with the offset between TTR and TTRc compensated. In this case, the offset value is compensated by using TDR of a unique SELT function of the ADSL equipment 200, and the obtained offset value is provided as the propagation delay value to the PLD 130.

As a result, according to the second embodiment of the invention, with the offset of a TTRp clock between TTR and TTRc being compensated using the propagation delay value between subscriber terminals acquired by the SELT TDR in the ADSL equipment 200, the TTRp clock is outputted to the DSP of the ADSL equipment 200.

As set forth above, the TTR offset control apparatus and method in an ADSL according to certain embodiments of the invention can programmably compensate TTR and TTRc offset by using an ADSL chip clock, PLL and PLD in order to prevent overlapping of FEXT noise sections where data is transmitted in a large quantity with NEXT noise sections. Thus, offset control can be performed programmably by operator manipulation to prevent crosstalk noise and to ensure stable data service.

Furthermore, the TTR offset control apparatus and method in the ADSL according to certain embodiments of the invention can acquire a propagation delay value between a TTR clock source and a present system by using a Time Domain Reflectometry (TDR) function of ADSL SELT (ITU-T G.922.1 Specification), and can compensate the offset of an acquired propagation delay value as much as delay by using a program of a PLD chip in order to prevent overlapping of FEXT noise sections where data is transmitted in a large quantity with NEXT noise sections, thus enabling stable data service.

While the present invention has been shown and described in connection with the preferred embodiments, it will be apparent to those skilled in the art that modifications and variations can be made without departing from the spirit and scope of the invention as defined by the appended claims.

What is claimed is:

1. An offset control method for matching Asynchronous Digital Subscriber Line (ADSL) equipment with Time-Compression Multiplexing Integrated Service Digital Network (TCM-ISDN) equipment, the method comprising the steps of:
synchronizing first and second clocks with each other, the first and second clocks being synchronized with a TTRc clock which is a reference clock for entering the ADSL equipment;
dividing the synchronized second clock into a predetermined magnitude of a third clock to produce a divided clock;
classifying the TTRc clock into high and low clocks by using the divided third clock, and counting the high and low clocks, respectively; and
compensating the counted high and low clocks according to a preset offset adjustment value so as to produce a compensated fourth clock, and providing the compensated fourth clock, together with the first and second clocks, to the ADSL equipment.

2. The offset control method according to claim 1, wherein the first clock is an NTR clock, the second clock is an ADSL DSP clock, and the fourth clock is a TTRp clock for entering the ADSL equipment.

3. The offset control method according to claim 1, wherein the preset offset adjustment value is a bit value set by a user with a switch.

4. The offset control method according to claim 1, wherein the preset offset adjustment value is a propagation delay value obtained by the ADSL equipment using Time Domain Reflectometry (TDR) of an SELT function.

5. An offset control method for matching Asynchronous Digital Subscriber Line (ADSL) equipment with Time-Compression Multiplexing Integrated Service Digital Network (TCM-ISDN) equipment, the method comprising the steps of:
synchronizing NTR and ADSL DSP clocks with each other, the NTR and ADSL DSP clocks being synchronized with a TTRc clock which is a reference clock for entering the ADSL equipment;
dividing the synchronized ADSL DSP clock into a predetermined magnitude to produce a divided clock;
classifying the TTRc clock into high and low clocks by using the divided clock, and counting the high and low clocks, respectively; and
compensating the counted high and low clocks in high and low periods, respectively, according to an offset adjustment value set by user selection to produce a compensated TTRp clock, and providing the compensated TTRp clock, together with the NTR and ADSL DSP clocks, to the ADSL equipment.

6. The offset control method according to claim 5, wherein the offset adjustment value is set by a user with a dip switch having a predetermined bit set according to an adjustment range.

7. The offset control method according to claim 5, wherein the NTR clock is an 8 KHz clock, the ADSL DSP clock is a 32.328 MHZ clock, the TTRc clock is a 400 Hz clock, and the divided clock is a 276 KHz clock.

8. The offset control method according to claim 5, wherein in the counting of the high and low clocks, each of the high and low clocks is counted with a 9-bit counter according to the divided clock.

9. An offset control method for matching Asynchronous Digital Subscriber Line (ADSL) equipment with Time-Compression Multiplexing Integrated Service Digital Network (TCM-ISDN) equipment, the method comprising the steps of:
synchronizing NTR and ADSL DSP clocks with each other, the NTR and ADSL DSP clocks being synchronized with a TTRc clock which is a reference clock for entering the ADSL equipment;
dividing the synchronized ADSL DSP clock into a predetermined magnitude to produce a divided clock;
classifying the TTRc clock into high and low clocks by using the divided clock, and counting the high and low clocks, respectively; and
offset-compensating the counted high and low clocks in high and low periods, respectively, according to a propagation delay value provided from the ADSL equipment so as to produce a compensated TTRp clock, and providing the compensated TTRp clock, together with the NTR and ADSL DSP clocks, to the ADSL equipment.

10. The offset control method according to claim 9, wherein the propagation delay value is acquired by the ADSL equipment using Time Domain Reflectometry (TDR) of an SELT function.

11. The offset control method according to claim 9, wherein the NTR clock is an 8 KHz clock, the ADSL DSP clock is a 32.328 MHZ clock, the TTRc clock is a 400 Hz clock, and the divided clock is a 1.1 MHZ clock.

12. The offset control method according to claim 9, wherein in the counting of the high and low clocks, each of the high and low clocks is counted with an 11-bit counter according to the divided clock.

13. An offset control apparatus for matching Asynchronous Digital Subscriber Line (ADSL) equipment with Time-Compression Multiplexing Integrated Service Digital Network (TCM-ISDN) equipment, the apparatus comprising:
a synchronizer for synchronizing first and second clocks with each other, the first and second clocks being synchronized with a TTRc clock which is a reference clock for entering the ADSL equipment; and
an offset compensator for dividing the synchronized second clock outputted from the synchronizer into a predetermined magnitude of a third clock, for classifying the TTRc clock into high and low clocks by using the divided third clock, for counting the high and low clocks respectively, and for compensating the counted high and low clocks according to a preset offset 1I adjustment value to produce a compensated fourth clock, and providing the compensated fourth clock, together with the first and second clocks, to the ADSL equipment.

14. The offset control apparatus according to claim 13, wherein the first clock is an NTR clock, the second clock is an ADSL DSP clock, and the compensated fourth clock is a TTRp clock for entering the ADSL equipment.

15. The offset control apparatus according to claim 13, further comprising an offset adjustment value selector for providing the preset offset adjustment value to the offset compensator according to user selection.

16. The offset control apparatus according to claim 15, wherein the preset offset adjustment value selector comprises a dip switch having a predetermined bit.

17. The offset control apparatus according to claim 13, wherein the preset offset adjustment value is a propagation delay value obtained by the ADSL equipment using Time Domain Reflectometry (TDR) of an SELT function.

18. An offset control apparatus for matching Asynchronous Digital Subscriber Line (ADSL) equipment with Time-Compression Multiplexing Integrated Service Digital Network (TCM-ISDN) equipment, the apparatus comprising:
a synchronizer for synchronizing NTR and ADSL DSP clocks with each other, the NTR and ADSL DSP clocks being synchronized with a TTRc clock;
an offset compensator for dividing the synchronized ADSL DSP clock provided from the synchronizer into a predetermined magnitude, for classifying the TTRc clock into high and low clocks by using the divided clock and counting the high and low clocks, respectively, for compensating the counted high and low clocks in high and low periods, respectively, according to a provided offset adjustment value so as to produce a compensated TTRp clock, and for providing the TTRp clock, together with the NTR and ADSL DSP clocks, to the ADSL equipment; and
an offset adjustment value selector for providing the offset adjustment value to the offset compensator according to user selection.

19. The offset control apparatus according to claim 18, wherein the offset adjustment value selector comprises a dip switch having a predetermined bit set according to an adjustment range.

20. The offset control apparatus according to claim 18, wherein the NTR clock is an 8 KHz clock, the ADSL DSP clock is a 32.328 MHZ clock, the TTRc clock is a 400 Hz clock, and the divided clock is a 276 KHz clock.

21. The offset control apparatus according to claim 18, wherein the offset compensator comprises counters, each for counting each of the high and low clocks according to the divided clock.

22. An offset control apparatus for matching Asynchronous Digital Subscriber Line (ADSL) equipment with Time-Compression Multiplexing Integrated Service Digital Network (TCM-ISDN) equipment, the apparatus comprising:
a synchronizer for synchronizing NTR and ADSL DSP clocks with each other, the NTR and ADSL DSP clocks being synchronized with a TTRc clock; and
an offset compensator for dividing the synchronized ADSL DSP clock into a predetermined magnitude, for classifying the TTRc clock into high and low clocks by using the divided clock and counting the high and low clocks, respectively, for offset-compensating the counted high and low clocks in high and low periods, respectively, according to a propagation delay value provided from the ADSL equipment so as to produce a compensated TTRp clock, and for providing the compensated TTRp clock, together with the NTR and ADSL DSP clocks, to the ADSL equipment.

23. The offset control apparatus according to claim 22, wherein the propagation delay value is acquired by the ADSL equipment using Time Domain Reflectometry (TDR) of an SELT function.

24. The offset control apparatus according to claim 22, wherein the NTR clock is an 8 KHz clock, the ADSL DSP clock is a 32.328 MHZ clock, the TTRc clock is a 400 Hz clock, and the divided clock is a 1.1 MHZ clock.

25. The offset control apparatus according to claim 22, wherein the offset compensator comprises counters, each for counting each of the high and low clocks according to the divided clock.
